(19) United States
(12) Patent Application Publication
(10) Pub. No.: US 2003/0125946 A1
(43) Pub. Date: Jul. 3, 2003

(54) Method and apparatus for recognizing animal species from an animal voice

(76) Inventor: Wen-Hao Hsu, Kaoshiung (TW)

Correspondence Address: Merchant & Gould PC, P O Box 2903, Minneapolis, MN, 55402-0903, US

(21) Appl. No.: 10/081,221

(22) Filed: Feb. 22, 2002

(30) Foreign Application Priority Data
Jan. 3, 2002 (TW) 91100038

(51) Int. Cl. G10L 17/00

(52) U.S. Cl. 704/246

(57) ABSTRACT

An apparatus and a method for recognizing animal species from an animal voice. Parameters of a animal voice are extracted and compared with a plurality of known animal voice parameters. If a match is found, animal species data corresponding to the known animal is displayed.

### BACKGROUND OF THE INVENTION

1. Field of the Invention

The present invention relates generally to recognizing animal species, and in particular to a method and apparatus for recognizing animal species from an animal voice and showing the user species data of the animal.

2. Description of the Related Art

There are many methods to recognize animal species, for example, DNA recognition and recognition by the shape of an animal. In the first method, a person should catch the animal and obtain a DNA sample from the animal. This may endanger the life of the animal or the person obtaining the DNA sample. In the second method, it is difficult to recognize the different of animal species.

### SUMMARY OF THE INVENTION

It is one object of the present invention to provide a method and apparatus for efficiently recognizing an animal species from an animal voice print. A user may go outdoors to watch animals with a mobile or portable device according to the present invention and obtain the species data corresponding to the animals according to their voice print. The species data may include the habitual behavior or the dispersion area. This provides helpful references about the nature.

The present invention is a method and apparatus for recognizing animal species, the method comprises the following steps: converting an animal voice into a target signal; extracting a target parameter vector according to the rhythm, tune or timbre of the target signal, and comparing the target parameter vector with a plurality of sample parameter vectors stored in a parameter database to obtain a match. If a sample parameter vector matching the target parameter is found, species data corresponding to the matching sample parameter vector stored in the parameter database is outputted.

The parameter database is established comprising the following steps: converting an animal voice into a sample signal, extracting a sample parameter vector according to the rhythm, tune or timbre of the voice of the sample signal, storing the sample parameter vector into the parameter database and storing species data corresponding to the sample parameter vector into the parameter database.

The apparatus of the present invention can be adopted in a mobile or portable device such as notebook PC or PDA and comprises the following: a voice signal collection device for receiving an animal voice and outputting a voice signal; a feature extraction module for extracting a target parameter vector according to the rhythm, tune or timbre of the voice signal; At least one storage device for storing a plurality of sample parameter vectors extracted from a plurality of known animal voices and species date corresponding to the sample parameter vectors; a comparison module for comparing the target parameter vector with the sample parameter vectors to obtain a matching sample parameter vector, Wherein the matching sample parameter vector is found than species data corresponding to the matching sample parameter vector stored in the parameter database is outputted; and at least one output device for displaying the species data corresponding to the matching sample parameter vector.

### BRIEF DESCRIPTION OF THE DRAWINGS

The present invention can be more fully understood by reading the subsequent detailed description in conjunction with the examples and references made to the accompanying drawings, wherein:

FIG. 1 illustrates the flow diagram of the method for recognizing animal species from the animal voice;

FIG. 2 illustrates the flow diagram of the method to establish the parameter database; and

FIG. 3 shows a block diagram of the apparatus for recognizing animal species from the animal voice in a notebook PC.

### DETAILED DESCRIPTION OF THE PREFERRED EMBODIMENT

In the following, the term “animal” refers to an animal organism other than a human.

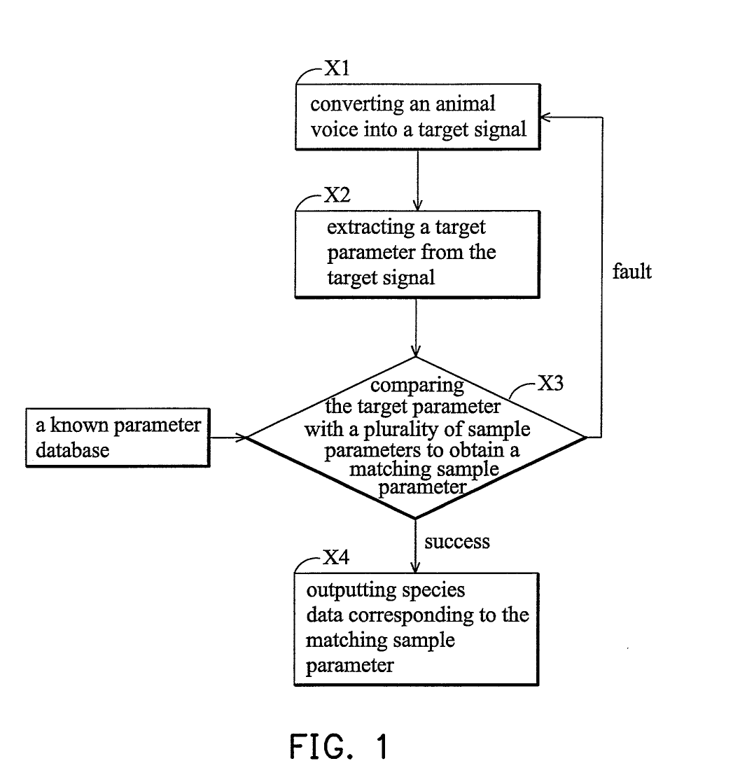

As illustrated in FIG. 1, the present invention provides a method for recognizing animal species from the animal voice. In step X1, an animal voice is converted into a target signal. In step X2, a target parameter vector is extracted according to the rhythm, tune or timbre of the target signal. In step X3, the target parameter vector is compared with a plurality of sample parameter vectors stored in a parameter database to obtain a matching sample parameter vector similar to the target parameter vector. The matching sample parameter vector and target parameter vector are separated by a minimum distant, in other words, the matching sample parameter is less difference from the target parameter vector compared to other sample parameter vectors. In step X4, species data corresponding to the matching sample parameter vector found in step X3 is outputted. Otherwise, the process can be repeated.

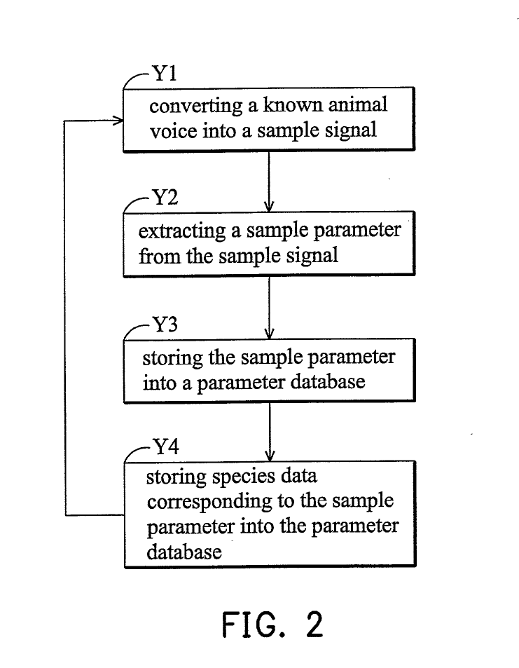

As illustrated in FIG. 2, the parameter database is established by the following steps. In step Y1, a known animal voice is converted into a sample signal. In step Y2, a sample parameter vector is extracted according to the rhythm, tune or timbre of the sample signal. In step Y3, the sample parameter vector is stored into the parameter database. In step Y4, species data corresponding to the sample parameter vector is stored into the parameter database. It is understood that some animal species produce varied sounds. In this case, a plurality of sample parameter vectors may correspond to the same species data. The process will be repeated for another known animal.

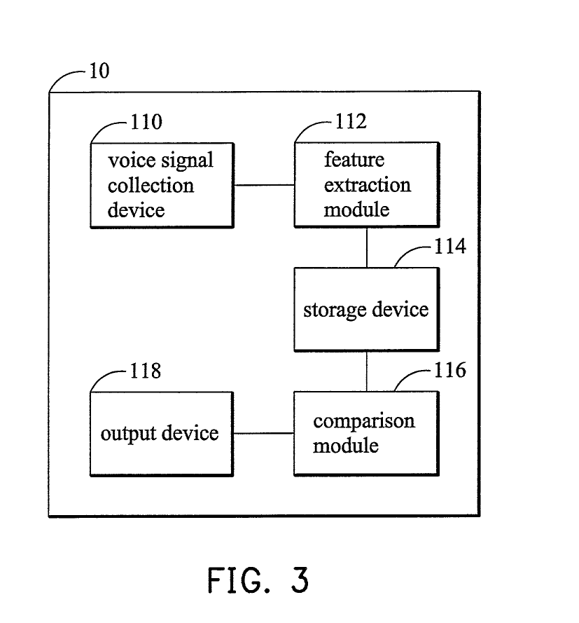

FIG. 3, illustrates a block diagram of the apparatus for recognizing animal species from the animal voice in a notebook PC. It is understood that the notebook PC 10 would be replaced with another mobile or portable device. A notebook PC 10 comprises a voice signal collection device 110 for receiving an animal voice and outputting a voice signal. The voice signal collection device 110 would be an audio card in the notebook PC 10. A feature extraction module 112 extracts a target parameter vector according to the rhythm, tune or timbre of the voice signal. The feature extraction module 112 is preferable a software module running in a CPU or a DSP in the notebook PC 10. At least one storage device 114 stores a plurality of sample parameter vectors extracted from a plurality of known animal voices and a plurality of species date corresponding to the sample parameter vectors. It is understood that some animals product varied voices. In this case, a plurality of animal voices may correspond to one of the animals. Thus a plurality of sample parameter vectors may correspond to one of the species data. The storage device 114 could be a hard disk or a memory in the notebook PC 10. A comparison module 116 compares the target parameter vector with the sample parameter vectors and obtains a matching sample parameter vector similar to the target parameter vector and outputs species data corresponding to the matching sample parameter vector to a output device 118, wherein the matching sample parameter vector and target parameter vector are separated by a minimum distance, in other words, the matching sample parameter vector is less different from the target parameter vector compared to other sample parameter vectors. The comparison module 116 is also preferable a software module running in a CPU or a DSP in the notebook PC 10. The output device 118 displays the species data output from the comparison module 116. This could be a monitor for displaying or an audio card in the notebook PC 10.

There are many methods known in the art for extracting a parameter according to the rhythm, tune or timbre of a voice or a known voice. For example, a delta energy parameter would be obtained by frame blocking a signal. A pitch parameter can be obtained by a method of AMDF(Average Magnitude Difference Function), auto-correlation, and FFT(Fast Fourier Transform) Moreover, a triangular bandpass filter could be used to obtain a Mel-Scale Cepstrum parameter vector and so on. Furthermore, there are many methods known in the art for comparing such parameters, such as DTW(Dynamic Time Warping) and HMM (Hidden Markov Model).

The present invention simply realizes the recognition of animal species by animal voices with a mobile or a portable device and displays species data corresponding to the animals. Some voices of animals are repeated and meaningless, for example, the voice of birds or inserts. These animals are easier to recognize.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for recognizing animal species from an animal voice, comprising;
a voice signal collection device for receiving the animal voice and outputting a voice signal;
a feature extraction module for extracting a target parameter from the voice signal;
at least one storage device for storing a plurality of sample parameter vectors extracted from a plurality of known animal voices and species data corresponding to the sample parameter vectors;
a comparison module for comparing the target parameter vector with the sample parameter vectors to find a matching sample parameter vector similar to the target parameter vector; and
at least one output device for displaying the species data corresponding to the matching sample parameter vector.

2. The apparatus as claimed in claim 1, wherein a plurality of sample parameter vectors correspond to one of the species data.

3. The apparatus as claimed in claim 1, wherein the feature extraction module extracts the target parameter vector according to the rhythm, tune or timbre of the voice signal.

4. The apparatus as claimed in claim 1, wherein the target parameter vector and the matching sample parameter vector have a minimum distance therebetween.

5. A method for recognizing animal species from an animal voice, the method comprising:
converting an animal voice into a target signal;
extracting a target parameter vector from the target signal;
comparing the target parameter vector with a plurality of sample parameter vectors stored in a parameter database to obtain a matching sample parameter vector which is similar to the target parameter vector; and
outputting species data corresponding to the matching sample parameter vector stored in the parameter database if the matching sample parameter vector is found.

6. The method as claimed in claim 5, wherein the parameter database is established by the steps comprising:
converting a known animal voice into a sample signal;
extracting a sample parameter vector from the sample signal;
storing the sample parameter vector into the parameter database; and
storing species data corresponding to the sample parameter vector into the parameter database.

7. The method as claimed in claim 5 and 6, wherein the steps of extracting the target parameter vector and the sample parameter vectors are according to the rhythm, tune or timbre of the target signal and the sample signal respectively.

8. The method as claimed in claim 5, wherein a plurality of sample parameter vectors correspond to one of the species data.

9. The method as claimed in claim 5, wherein the matching sample parameter vector and the target parameter have a minimum distance therebetween.
